(19) United States
(12) Patent Application Publication
(10) Pub. No.: US 2021/0027365 A1
(43) Pub. Date: Jan. 28, 2021

(54) METHOD AND SYSTEM FOR USING TEST DEPOSITS TO DETECT UNLISTED ACCOUNTS ASSOCIATED WITH USERS OF A DATA MANAGEMENT SYSTEM

(71) Applicant: Intuit Inc., Mountain View, CA (US)

(72) Inventors: Yehezkel S. Resheff, Tel Aviv (IL); Tzvika Barenholz, Raanana (IL); Yair Horesh, Kfar-Saba (IL); Shimon Shahar, Rishon-Letziyon (IL)

(73) Assignee: Intuit Inc., Mountain View, CA (US)

(21) Appl. No.: 16/522,075

(22) Filed: Jul. 25, 2019

(51) Int. Cl. G06Q 40/02; G06Q 20/40

(52) U.S. Cl. CPC G06Q 40/02; G06Q 20/4014

(57) ABSTRACT

Test deposit mechanisms used by financial institutions to link accounts are used to identify undisclosed accounts associated with users of a data management system. The potential existence of undisclosed accounts is determined based on the assumption that the presence of test deposit transactions in user account data is a strong indication that an undisclosed user account exists. Using this assumption, transaction data from user accounts disclosed to a user data management system is scanned to identify test deposit transactions listed in the transaction data. If test deposit transactions are identified, the user of the data management system is queried regarding the existence of the undisclosed user account. If the user confirms the existence of the undisclosed account, the formally undisclosed account is added to a set of disclosed user accounts with the data management system.

### BACKGROUND

Data management systems, such as transaction management systems, personal financial management systems, small business management systems, and tax preparation systems, have proven to be valuable and popular tools for helping users of these systems perform various tasks and manage their personal and professional lives. Many currently available data management systems use account aggregation to obtain the data necessary to provide users of these data management systems various features and services.

Account aggregation is the process of obtaining access to accounts identified as being associated with a user, and then collecting user account data, such as transaction data, from one or more the disclosed user accounts. The data management systems then process the collected account data from all disclosed, or identified, accounts to provide the user with analysis and recommendations such as various reports, advice, snapshots, and other features in a holistic way based on theoretically complete and current data.

To provide users of an account aggregating data management system accurate analysis and recommendations, it is important that the data management system obtain as complete a set of the users' data as possible. Since the users account data is obtained from disclosed accounts associated with the users, it follows that obtaining a complete set of account data requires the identification/disclosure of a complete set of accounts associated with the users.

In order to provide account aggregating data management systems with access to the disclosed accounts associated with a user, the user typically provides, directly or indirectly, a listing, or set, of their associated user accounts. Herein, these user accounts are referred to as “disclosed,” or “identified,” user accounts. Typically, the disclosed user accounts are identified by the user providing account identification data to the data management system at the time the user first signs up to use the data management system.

In addition to providing account identification data, the user also typically provides the data management system with account access and permissions credentials data for the disclosed accounts so that the data management system can access the user's account data contained in the disclosed user accounts. In many cases, the data management system uses the provided account access and permissions credentials data to access the disclosed accounts and then employs one of various available methods of data scraping to obtain the desired data contained in the disclosed accounts.

Despite the need for providing as complete a set of user accounts as possible to the account aggregating data management system, is often the case that one or more accounts associated with a given user are not disclosed to the account aggregating data management system. These “undisclosed,” or “unidentified,” user accounts exist for one of several reasons such as the user forgetting or otherwise omitting the inclusion of one or more user accounts in the set of disclosed user accounts provided to the account aggregating data management system, or the user opening, obtaining, or otherwise gaining access to, new user accounts and not identifying these new accounts to the account aggregating data management system.

Currently, based on the empirical data associated with existing users of account aggregating data management systems, it is estimated that between 22% and 46% of users of account aggregating data management systems have at least one undisclosed user account that should be disclosed to the account aggregating data management system.

This is a significant problem in the account aggregation and data management system fields because these undisclosed accounts may result in reports, features, advice, and data analysis that are incomplete because the complete set of account data required for accurate processing is not available to the data management system. This is particularly problematic in cases where the reports and features provided through the data management system are relied on by the users to make important decisions and to understand their current and future status.

What is needed is an effective, efficient, and accurate solution to the long-standing technical problem of identifying undisclosed accounts associated with users of account aggregation data management systems.

### SUMMARY

The systems and methods of the present disclosure provide a technical solution to the problem of identifying undisclosed user accounts by leveraging the test deposit mechanisms used by many financial institutions to link accounts between financial institutions.

Using the disclosed embodiments, when test deposit transactions are identified in a disclosed user account, it is determined highly likely that there is a potential undisclosed user account in existence. Consequently, once test deposit transactions are identified in a disclosed user account, the user of the data management system is asked about the existence of the undisclosed user account.

If the user confirms the existence of the undisclosed user account, the status of the undisclosed account is changed to newly identified user account and account data associated with the newly identified user account is obtained. The newly identified user account is then added to the list of disclosed user accounts with the data management system, i.e., the status of the newly identified user account is transformed to disclosed user account status.

As a result of these, and other features discussed in more detail below, the disclosed embodiments provide an extremely efficient, effective, and flexible technical solution to the technical problem of identifying undisclosed accounts associated with a user of a data management system.

As noted, the disclosed embodiments treat the existence of test deposits in a disclosed user account as a strong indication that there is a potential undisclosed user account. Test deposits are used by financial institutions, such as banks, when a user desires the link two user accounts with two separate financial institutions. Typically, the user desires to create a link between the two user accounts so that funds can be transferred between the two user accounts. However, the linking of two user accounts from different financial institutions is inherently subject to fraud or mistakes.

To address these risks, before allowing the user to link the two user accounts with two different financial institutions, a financial institution associated with the first of the two user accounts must ensure that the correct user account data for the second user account is being used and that the user has access to the transaction data in the second user account. The assumption is that if the user has the correct account information for the second user account and can access the transaction data in the second user account, then the user is legitimately associated with the second user account.

To this end, the financial institution associated a first of the two user accounts makes one or more small deposits in relatively rapid succession into the second user account associated with the second financial institution. Typically, two test deposits of less than one dollar each are made. Typically, the test deposits are made within a very short time of each other, often within minutes or seconds of each other, so that both test deposits can be readily found in a list of user transactions in the account data of the second user account.

Once the test deposits are made, the user is then asked to access the transaction data in the second user account and report back to the first financial institution the exact amount of the one or more small deposits. Using this test deposit mechanism, when the user reports back to the first financial institution the exact amount of the one or more small deposits, this is considered a confirmation that the correct second user account information has been obtained and that the user has access to the account data in the second user account. Therefore, the capability to successfully transfer funds between the two user accounts, and two financial institutions, is considered confirmed and user is determined to be legitimately associated with the second user account with the second financial institution.

The systems and methods of the present disclosure leverage this test deposit mechanism based on the assumption that the existence of test deposit transactions in a disclosed user account is a strong indication that an undisclosed user account has been opened and is being linked to the disclosed user account where the test deposits were made.

Using the disclosed embodiments, the test deposits are identified by obtaining transaction data from all the user accounts disclosed to a data management system used by the user. The transaction data is then scanned and analyzed to identify test deposit transactions listed in the transaction data.

Identifying test deposit transactions is typically a straightforward process because, as noted above, test deposit transactions are usually made in pairs, are of small amounts, smaller than a typical “real” transaction, and have very similar date and time values. The concurrence of these three factors in any real transaction is highly unlikely. Consequently, test deposits are readily recognized based on these standard transaction data features alone.

However, in addition, many test deposit transactions include text in the description field of the test deposit transactions indicating the transaction is a test deposit. In these cases, identifying a test deposit transaction is a trivial task. Further, some test deposit transactions also identify the financial institution sending the test deposit. In these cases, the identity of the financial institution associated with the test deposit transactions is also trivial. Therefore, identifying test deposit transactions in disclosed user account transaction data, and often identifying the financial institutions associated with the test deposits, can be performed efficiently, effectively, and accurately using standard data analysis and scanning techniques.

As noted above, using the disclosed embodiments, when test deposit transactions are identified in a disclosed user account, is determined highly likely that there is a potential undisclosed user account in existence. Consequently, once test deposit transactions are identified in a disclosed user account, the user of the data management system is queried regarding the existence of the undisclosed user account.

If the user confirms the existence of the undisclosed user account, the status of the undisclosed account is changed to newly identified user account and account data associated with the newly identified user account is obtained. The newly identified user account is then added to the list of disclosed user accounts with the data management system, i.e., the status of the newly identified user account is transformed to disclosed user account status.

### BRIEF DESCRIPTION OF THE DRAWINGS

FIG. 1 is a high-level block diagram of a production environment for implementing a method and system for using test deposits to detect undisclosed accounts associated with users of a data management system in accordance with one embodiment.

FIG. 2 is an illustrative example of disclosed user account data arranged in a user account table that includes disclosed user accounts and user account access credentials for the user's disclosed user accounts in accordance with one embodiment.

FIG. 3 is a more detailed diagram of the operation of a test deposit detection module that is part of an undisclosed user account detection module in accordance with one embodiment.

FIG. 4A is an illustrative example of user transaction data to be analyzed by a test deposit detection module in accordance with one embodiment.

FIG. 4B is an illustrative example of a pair of test deposit transactions included the user transaction data of FIG. 4A in accordance with one embodiment.

FIG. 5 is an illustrative example of the user account table of FIG. 2 after a potential undisclosed user account is detected and added to the user account table in accordance with one embodiment.

FIG. 6 is a more detailed block diagram of a potential undisclosed user account alert processing module in accordance with one embodiment.

FIG. 7 shows an illustrative example of a potential undisclosed user account alert provided to a user computing system in accordance with one embodiment.

FIG. 8 is an illustrative example of the user account table of FIGS. 2 and 5 after the potential undisclosed user account has been designated a newly identified user account and the newly identified user account has been detected and added to the disclosed user account data of the account table in accordance with one embodiment.

FIG. 9 is a flow chart representing a process for using test deposits to detect undisclosed accounts associated with users of a data management system in accordance with one embodiment.

Common reference numerals are used throughout the FIGs. and the detailed description to indicate like elements. One skilled in the art will readily recognize that the above FIGs. are merely illustrative examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGs., which depict one or more exemplary embodiments. Embodiments may be implemented in many different forms and should not be construed as limited to the embodiments set forth herein, shown in the FIGs., and/or described below. Rather, these exemplary embodiments are provided to allow a complete disclosure that conveys the principles of the invention, as set forth in the claims, to those of skill in the art.

The systems and methods of the present disclosure operate on the principle that the presence of test deposit transactions in a disclosed user account is a strong indication that a new, or undisclosed, user account exists. Using this fact, the disclosed embodiments scan user transaction data for the presence of test deposit transactions. If test deposit transactions are detected, it is determined to be highly likely that there is a potential undisclosed user account in existence. Consequently, once test deposit transactions are identified, the user of the data management system is asked about the existence of an undisclosed user account.

If the user confirms the existence of the undisclosed user account, the status of the undisclosed account is changed to newly identified user account and account data for the newly identified user account is obtained from the user. The newly identified user account is then added to the list of disclosed user accounts with the data management system.

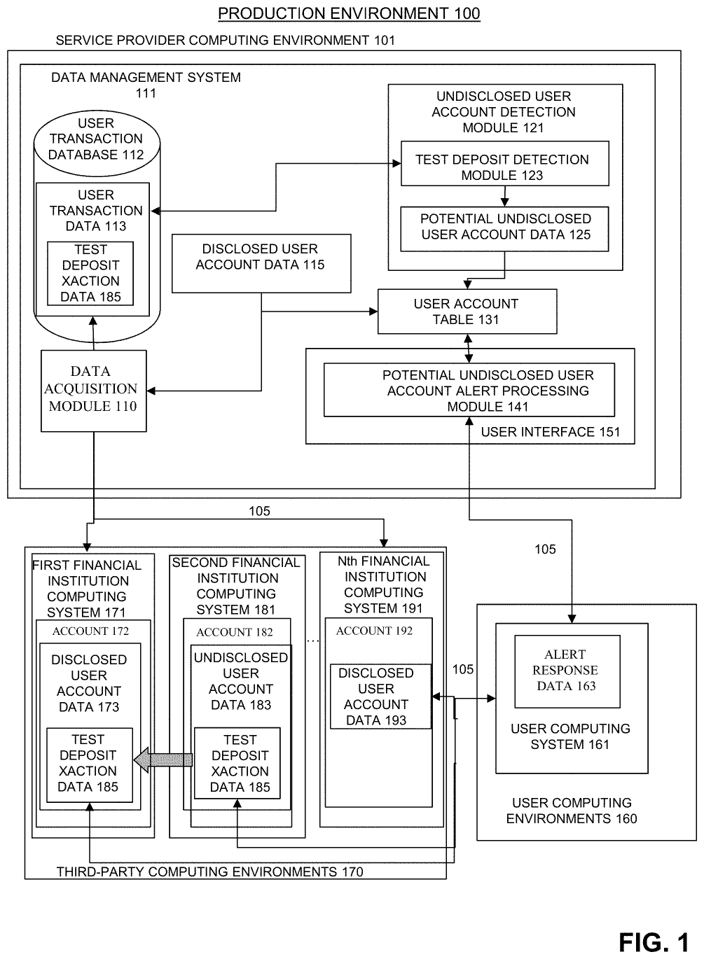

FIG. 1 is a high-level block diagram of a production environment 100 for implementing a system for using test deposits to detect undisclosed accounts associated with users of a data management system in accordance with one embodiment.

As seen in FIG. 1, production environment 100 includes service provider computing environment 101, user computing environments 160, and third-party computing environments 170, all communicatively coupled to one another via one or more communication channels, represented in FIG. 1 by communication channels 105.

Service provider computing environment 101 includes data management system 111. In the specific illustrative example of FIG. 1, data management system 111 can be any account aggregating data management system as discussed herein, known in the art at the time of filing, or as made available after the time of filing. As a specific illustrative examples, data management system 111 can be one or more of a business financial transaction management system, a personal financial management system, a tax-preparation system, a business accounting system, a business inventory system, or any other system that manages, processes, or otherwise manipulates account data associated with users of the data management system 111.

Data management system 111 includes user transaction database 112 including user transaction data 113. User transaction data 113 can be obtained from one or more transaction data sources including, but not limited to, one or more third-party financial institution computing systems 171 or 191, which represent “N” third-party financial institution computing systems associated with one or more third party financial institutions providing financial accounts to users of data management system 111. User transaction data 113 and financial institution computing systems 171, 181, through 191 are discussed in more detail below.

As noted, in the specific illustrative example of FIG. 1, data management system 111 is an account aggregating data management system. Consequently, data management system 111 requires access to accounts and account data associated with the user. In order to provide data management system 111 with access to the accounts associated with the user, the user typically provides, directly or indirectly, a set of their associated user accounts. Herein, these user accounts are referred to as “disclosed” user accounts. Typically, the disclosed user accounts are identified by the user providing disclosed user account data 115 to data management system 111 at the time the user first signs up to use data management system 111. Typically, the user provides disclosed user account data 115 to data management system 111 from user computing system 161 through communication channels 105 and user interface 151 of data management system 111.

In addition to providing account identification data, the user also typically provides the data management system 111 with disclosed account access and permissions credentials data that is then included in disclosed user account data 115. As discussed below, this allows the data management system 111 to access the user's account data contained in the disclosed user accounts of disclosed user account data 115. In many cases, as part of the data aggregation process, once data management system 111 uses the provided disclosed account access and permissions credentials data of disclosed user account data 115 to access the disclosed user accounts, the data management system then employs one of various available methods of data scraping to obtain the desired user account data contained in the disclosed user accounts of disclosed user account data 115.

Once the user provides disclosed user account data 115 to data management system 111, the account identification data and disclosed account access and permissions credentials data for the disclosed user accounts can be collected in a disclosed user account data portion of a user account table 131.

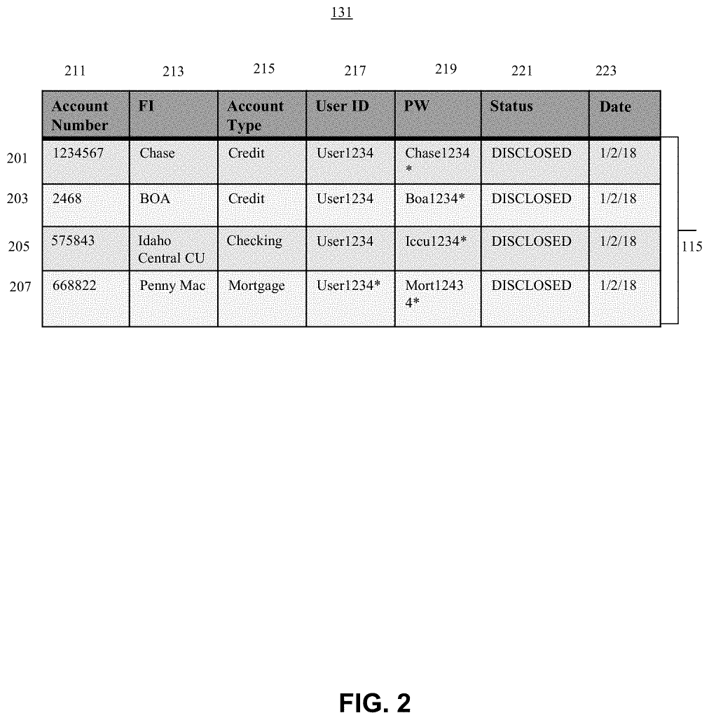

FIG. 2 is an illustrative example of disclosed user account data 115 organized in a user account table 131 including disclosed user accounts shown in rows 201, 203, 205, and 207, and user account access credentials for the disclosed user accounts in accordance with one embodiment.

As seen in FIG. 2, each of the disclosed user accounts of rows 201, 203, 205, and 207 includes account number data in column 211, the name of the financial institution associated with the disclosed user account (FI) in column 213, the account type in column 215, the user ID used to sign into the account in column 217, the password (PW) for the account in column 219, the status of the account, e.g., disclosed or undisclosed, in column 221, and the date the account was identified with the data management system in column 223.

Returning to FIG. 1, financial institution computing systems 171, 181, through 191 are computing systems, such as, but not limited to, one or more databases, servers, web-hosting systems, or data centers, used to provide services to the user such as, but not limited to, one or more, of account access, account data presentation, transaction listings, on-line banking, and the like. In the specific illustrative example of FIG. 1, each of financial institution computing systems 171, 181, through 191 is associated with a respective financial institution that provides one or more accounts to the user of the data management system 111.

In the specific illustrative example of FIG. 1, a first financial institution (not shown) associated with first financial institution computing system 171 provides an account 172 to the user of data management system 111. In the specific illustrative example of FIG. 1, the user account 172 with the first financial institution is one of the accounts the user has disclosed to the data management system 111 in disclosed user account data 115, i.e., the user account 172 with the first financial institution is a disclosed user account. Consequently, in this specific illustrative example, first financial institution computing system 171 includes disclosed user account data 173 representing account data, including transaction data representing the financial transactions conducted by the user using the disclosed user account 172 associated with first financial institution computing system 171.

Similarly, in the specific illustrative example of FIG. 1, a second financial institution (not shown) associated with second financial institution computing system 181 provides an account 182 to the user of data management system 111. In the specific illustrative example of FIG. 1, the user account 182 with the second financial institution is not one of the accounts the user has disclosed to the data management system 111 in disclosed user account data 115, i.e., the user account 182 with the second financial institution is an undisclosed user account. Consequently, in this specific illustrative example, second financial institution computing system 181 includes undisclosed user account data 183 representing account data, including transaction data representing the financial transactions conducted by the user using the undisclosed user account 182 associated with second financial institution computing system 181.

Similarly, in the specific illustrative example of FIG. 1, an Nth financial institution (not shown) associated with Nth financial institution computing system 191 provides an account 192 to the user of data management system 111. In the specific illustrative example of FIG. 1, the user account 192 with the Nth financial institution is one of the accounts the user has disclosed to the data management system 111 in disclosed user account data 115, i.e., the user account 192 with the Nth financial institution is a disclosed user account. Consequently, in this specific illustrative example, Nth financial institution computing system 191 includes disclosed user account data 193 representing account data, including transaction data representing the financial transactions conducted by the user using the disclosed account 192 associated with Nth financial institution computing system 191.

In operation, the data management system 111 utilizes a data acquisition module 110 to retrieve user transaction data 113 related to the financial transactions of the users of the data management system 111. The data acquisition module 110 can be configured to use disclosed user account data 115 to acquire user transaction data 113 related to financial transactions of the users. In particular, the data acquisition module 110 uses the disclosed account access and permissions credentials data of disclosed user account data 115 to log into the online services of the disclosed user accounts of disclosed user account data 115 and provided through financial institution computing systems, such as financial institution computing systems 171 and 191 in FIG. 1.

Once access to the disclosed user accounts, such as user accounts 172 and 192, of third-party financial institution computing systems, such as financial institution computing systems 171 and 191 in FIG. 1, is obtained, user transaction data 113 can be collected using one or more transaction data acquisition methods known to those of skill in the art, such as screen scraping, or any other method of obtaining user transaction data discussed herein, and/or as known in the art at the time of filing, and/or as made available after the time of filing.

The user transaction data 113 can include debit card transactions, credit card transactions, credit card balances, bank account deposits, bank account withdrawals, credit card payment transactions, online payment service transactions such as PayPal transactions or other online payment service transactions, loan payment transactions, investment account transactions, retirement account transactions, mortgage payment transactions, rent payment transactions, bill pay transactions, budgeting information, financial goal information, or any other types of financial data. The user transaction data 113 can also include data related to withdrawals, deposits, and balances in the bank accounts of users.

The user transaction data 113 can include, for each financial transaction represented in user transaction data 113, one or more of: time stamp data corresponding to a time stamp that indicates the date and time of the financial transaction; location data representing the location of the transaction; amount data representing the amount of the transaction; and payee data representing the merchant or payee associated with the transaction. In addition, user transaction data 113 can include, for each financial transaction, description data indicating the items purchased or transaction category assigned to the transaction.

It is important to note that data acquisition module 110 and disclosed user account data 115 can only be used to access and acquire account data from disclosed user accounts made known to the data management system via disclosed user account data 115. Consequently, user transaction data 113 only includes transaction data from the disclosed user accounts of disclosed user account data 115.

It follows that, in the specific illustrative example of FIG. 1, only disclosed user account data 173 of account 172 and disclosed user account data 193 of account 192 can be acquired from first financial institution computing system 171 and Nth financial institution computing system 191, respectively, using data acquisition module 110 and disclosed user account data 115. In contrast, the undisclosed user account data 183 of undisclosed user account 182 in second financial institution computing system 181 cannot be accessed using data acquisition module 110 and disclosed user account data 115 because the user account 182 of the second financial institution computing system 181 is an undisclosed account. As a result, in this specific illustrative example of FIG. 1, user transaction data 113 only includes account and transaction data from disclosed user account data 173 and disclosed user account data 193.

As discussed above, to provide users of an account aggregating data management system, such as data management system 111, accurate analysis and recommendations, it is important that data management system 111 obtain as complete a set of the users' account data as possible, i.e., that the set of account and transaction data included in user transaction data 113 be as complete as possible. If data management system 111 is not provided a complete set of the users' account and transaction data included in user transaction data 113, then the analysis and recommendations provided to the users may be incorrect or, at best, be based on incomplete input data. It follows that, in the specific illustrative example of FIG. 1, the fact that user transaction data 113 only includes account and transaction data from disclosed user account data 173 and disclosed user account data 193, but not undisclosed user account data 183, is problematic.

Since the user's account and transaction data included in user transaction data 113 can only be obtained from the disclosed user accounts of disclosed user account data 115, it follows that obtaining a complete set of user account and transaction data requires the identification of a complete set of user accounts in disclosed user account data 115.

In short, the quality of the various reports, visualizations, and recommendations generated and provided by data management system 111 is directly proportional to the percentage of the total number of user accounts that are disclosed to the data management system 111 via disclosed user account data 115. Consequently, it is important that disclosed user account data 115 include a set of disclosed accounts associated with a user that is as complete possible.

However, as also discussed above, despite the need for providing as complete a set of user accounts in disclosed user account data 115 as possible, it is often the case that one or more accounts associated with a given user, such as account 182 in FIG. 1, are not listed in disclosed user account data 115 and therefore are not identified to the data management system 111. These “undisclosed” user accounts, such as account 182 in FIG. 1, exist for one of several reasons such as the user forgetting or otherwise omitting the inclusion of one or more user accounts in the disclosed user account data 115 provided to account aggregating data management system 111, or the user opening, obtaining, or otherwise gaining access to, new user accounts and not disclosing these new accounts to account aggregating data management system 111.

To address this issue, the systems and methods of the present disclosure leverage the test deposit mechanisms used by many financial institutions to detect potential undisclosed user accounts, such as account 182, that are not listed in disclosed user account data 115.

As noted above, test deposits are used by financial institutions when a user desires to link two user accounts provided by two separate financial institutions to address security risks, before allowing the user to link the two user accounts provided by two different financial institutions. Using the test deposit mechanism, the financial institution associated a first of the two user accounts makes one or more small deposits in relatively rapid succession into the second user account associated with the second financial institution. Typically, two test deposits of less than one dollar each are made. Typically, the test deposits are made within a very short time of each other, often within minutes or seconds of each other, so that both test deposits can be readily found in a set of user transactions in the account data of the second user account.

Once the test deposits are made, the user is then asked to access the transaction data in the second user account and report back to the first financial institution the exact amount of the one or more small deposits. If the user reports back the exact amount of the small deposits, this is considered a confirmation that the capability to successfully transfer funds between the two user accounts exists and the user is legitimately associated with the second user account.

Returning to FIG. 1, the user of data management system 111 has a disclosed user account 172 with a first financial institution and an undisclosed user account 182 with a second financial institution. In this specific illustrative example, the user has linked disclosed user account 172 with undisclosed user account 182.

Using the test deposit mechanism described above, before linking the accounts, second financial institution transmitted test deposit transaction data 185 representing test deposit transactions, typically two test deposits, from second financial institution computing system 181 to first financial institution computing system 171 and first financial institution disclosed user account 172. As a result of the transfer of the test deposits represented in test deposit transaction data 185 being transferred to first financial institution disclosed user account 172, test deposit transaction data 185 will be included in the transaction data of disclosed user account data 173 of the first financial institution disclosed user account 172. In accordance with the embodiments discussed herein, it is the presence of this test deposit transaction data 185 in the transaction data of disclosed user account data 173 of the disclosed first financial institution account 172 that is to identify the existence of undisclosed user account 182, and in some cases the identity of the second financial institution.

To this end, using the disclosed embodiments, when data management system 111 utilizes data acquisition module 110 to retrieve user transaction data 113, data acquisition module 110 uses disclosed user account data 115 to access all of the disclosed user accounts in disclosed user account data 115, which includes the disclosed user account data 173 of disclosed user account 172 in first financial institution computing system 171. Even through data acquisition module 110 still cannot access undisclosed user account 182, and undisclosed user account data 183, by accessing and obtaining disclosed user account data 173 of disclosed user account 172, data acquisition module 110 obtains test deposit transaction data 185 representing the test deposit transactions from the second financial institution to disclosed user account 172. Consequently, user transaction data 113 will also include test deposit transaction data 185.

According to the disclosed embodiments, user transaction data 113, including test deposit transaction data 185, is provided to test deposit detection module 123 of undisclosed user account detection module 121. Test deposit detection module 123 uses a detection process 300 to analyze user transaction data 113 and identify test deposit transaction data, such as test deposit transaction data 185, in user transaction data 113.

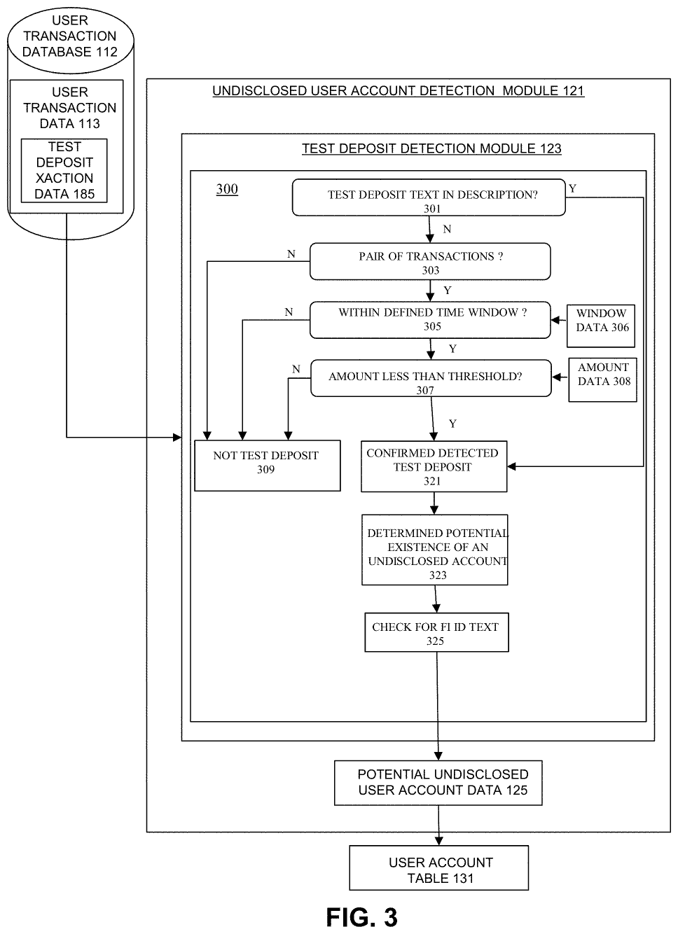

FIG. 3 is a more detailed diagram of the operation of a test deposit detection module 123 and detection process 300. Referring now to FIGS. 1, 2, and 3, test deposit detection module 123 receives user transaction data 113 from user transaction database 112. As discussed above, by virtue of obtaining access to disclosed user account data 173 of disclosed user account 172, data acquisition module 110 obtains test deposit transaction data 185 which is included in user transaction data 113.

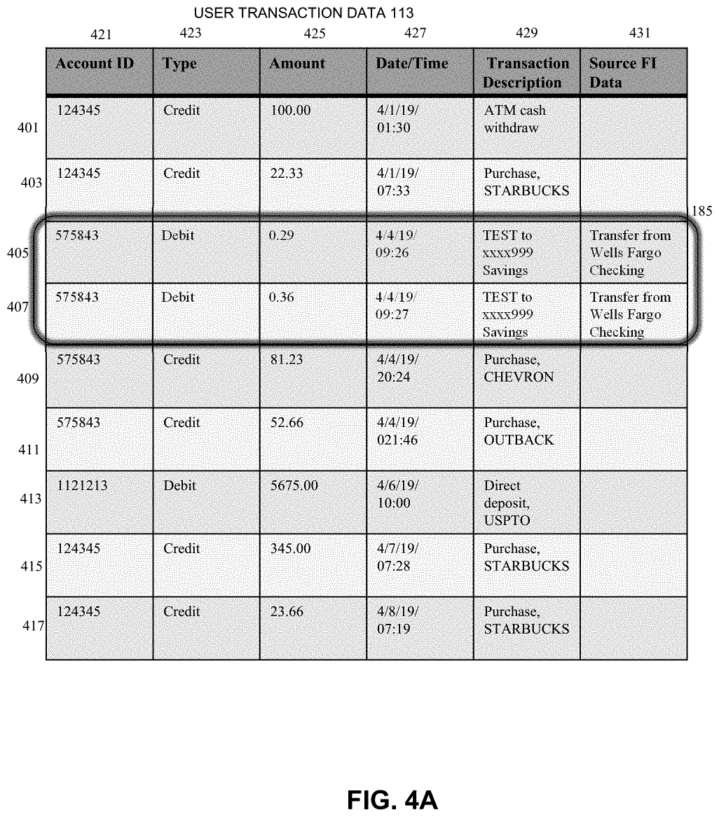

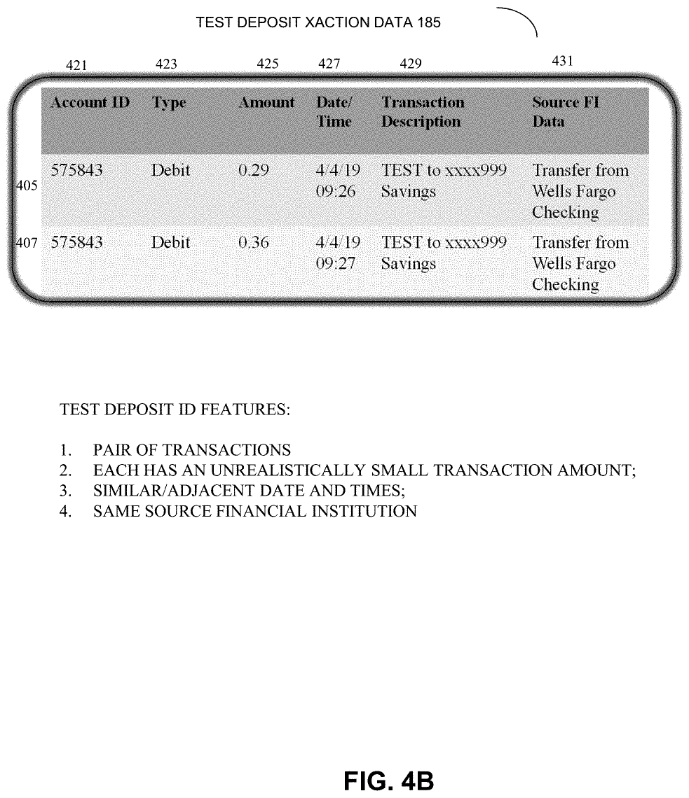

FIG. 4A is an illustrative example of user transaction data 113 provided to test deposit detection module 123.

As seen in FIG. 4A, in this specific illustrative example, user transaction data 113 is processed transaction data representing nine user transactions arranged in rows 401, 403, 405, 407, 409, 411, 413, 415, and 417. Each transaction includes data columns 421, 423, 425, 427, 429 and 431.

As seen in FIG. 4A, data column 421 includes account ID data indicating the user account associated with the transaction; data column 423 includes account type data indicating the type of transaction, e.g., debit or credit; data column 425 includes amount data indicating the amount of the transaction; data column 427 includes date/time data indicating the date and time of the transaction; data column 429 includes transaction description data including selected transaction description data associated with the transaction; and data column 431 includes source FI data indicating the financial institution generating the transaction data.

Typically, user transaction data 113 can include numerous formats, abbreviations and greater or fewer types of transaction data. Consequently, user transaction data 113 must typically undergo some form of formatting, such as any formatting known in the art, to generate consistent structured data for all user transactions.

In addition, those of skill in the art will readily recognize that the various types of data shown in the specific illustrative example of FIG. 4A are merely representative of numerous types of data that may be included in user transaction data 113. In many cases, only a subset of the types of data shown in FIG. 4A may be present and, in other cases, more types of data can be present in user transaction data 113.

Of note in FIG. 4A are the test deposit transactions, shown as test deposit transaction data 185 in FIG. 4A and FIG. 1, including the pair of transactions of rows 405 and 407. As discussed below, the test deposit transaction data 185 transaction pair including transactions of rows 405 and 407 is representative of a pair of test deposit transactions included in test deposit transaction data 185 of FIG. 1.

FIG. 4B shows test deposit transaction data 185, including the test deposit transactions of rows 405 and 407 of FIG. 4A, in isolation for illustrative purposes. As seen in FIG. 4B, the transactions of rows 405 and 407: are a pair of transactions; have the same account ID data in column 421; are the same type of transaction, i.e., debit, as indicated by the type data in column 423; involve unrealistically small amounts as indicated by the amount data of column 425; took place at almost the same time, i.e., within a minute of each other, as indicated by the time/date data of column 427; include, in this specific illustrative example, the terms “test” in the obtained description data of column 429; and, in this specific illustrative example, come from the same financial institution, Wells Fargo, as indicated by the source FI data in column 431.

Given the features typically associated with test deposit transactions, such as those shown in FIGS. 4A and 4B, identifying test deposit transactions is typically a straightforward process because, as noted above, test deposit transactions are usually made in pairs, are of small amounts, smaller than a typical “real” transaction, and have very similar date and time values. The concurrence of these three factors in any real transaction is highly unlikely. Consequently, test deposits are readily recognized based on these standard transaction data features alone.

In n addition, many test deposit transactions, such as those shown in rows 405 and 407 of FIGS. 4A and 4B, include text in the description field of the test deposit transactions indicating the transaction is a test deposit, as shown in obtained description column 427 in FIGS. 4A and 4B. In these cases, identifying a test deposit transaction is a trivial task.

Further, some test deposit transactions, such as those shown in rows 405 and 407 of FIGS. 4A and 4B, identify the financial institution sending the test deposit, shown in source FI data column 431 in FIGS. 4A and 4B. In these cases, the identity of the financial institution associated with the test deposit transactions is also readily made Therefore, identifying test deposit transactions in disclosed user account transaction data, and often the identity of the financial institutions associated with the test deposits, can be performed efficiently, effectively, and accurately using standard data analysis and scanning techniques.

Returning to FIGS. 3, 4A, and 4B, when user transaction data 113, such as that shown in FIGS. 4A and 4B, is provided to test deposit detection module 123, detection process 300 is used to analyze user transaction data 113. At test deposit text in description? 301, the user transaction data 113 is first processed to detect text in the description data associated with the transactions represented in user transaction data 113 indicating the transaction is a test deposit, such as the data in column 427 for rows 405 and 407 of FIGS. 4A and 4B. As noted, if this data is detected, then identifying a test deposit transaction is a trivial task and the transaction is labeled a confirmed detected test transaction at confirmed detected test deposit transaction 321.

However, if text in the description data associated with the transactions represented in user transaction data 113 indicating the transaction is a test deposit is not identified, process 300 proceeds to operations 303, 305, and 307. In this case, all three requirements of operations 303, 305, and 307 must be met, e.g., a yes (Y) response must be generated, for transactions to be confirmed as detected test transactions at confirmed detected test deposit transaction 321.

As noted above, test deposit transactions typically have transaction data features that are unique to test deposits transactions and are readily identified when all these features are present. These test deposit account features include: a pair of deposit transactions to the same disclosed user account; both transactions occurring within a short time of each other, often within minutes or seconds of each other; and both transactions having very small transaction amounts, typically less than a US dollar, and often only a few cents. According to the disclosed embodiments, this fact is used by test deposit detection module 123 and detection process 300 to identify test deposit transactions in user transaction data 113.

To this end, at pair of transactions? 303, user transaction data 113 is analyzed to identify pairs of deposit, or debit, transactions into the same disclosed user account, with the attributes discussed above and scanned for at operations 305 and 307.

As a specific illustrative example, the pair of transactions shown in rows 405 and 407 of FIGS. 4A and 4B of test deposit transaction data 185 have the same account ID data in column 421. Consequently, this pair of transactions moves on to within defined time window? 305. Transactions that are not in pairs are filtered out at pair of transactions? 303 and sent to not test deposit 309.

At within defined time window? 305, pairs of deposit transactions from pair of transactions? 303 having dates and times within a defined time window are identified. As noted above, test deposit transactions are typically sent within a very small-time frame, such as minute or seconds. Consequently, the defined time window can be seconds, minutes, an hour, or even a day, but typically not a window greater than a day.

As a specific illustrative example, pairs of debit transactions, such as those shown in rows 405 and 407 of FIGS. 4A and 4B of test deposit transaction data 185, having the same account ID data in column 421 and date and time data in column 427 that fall within a time window defined by window data 306 in FIG. 3 are identified and forwarded to amount less than threshold? 307. Pairs of transactions that do not fall within a time window defined by window data 306 in FIG. 3 are filtered out at within defined time window? 305 and sent to not test deposit 309.

At amount less than threshold? 307, pairs of transactions from within defined time window? 305 are analyzed to determine if both transactions have amounts less than a defined threshold amount. As noted above, test deposit transactions typically have very small transaction amounts, typically less than would be practical for a real transaction. Consequently, defined threshold amount can be a US dollar, or even a fraction of a US dollar.

As a specific illustrative example, pairs of debit transactions, such as those shown in rows 405 and 407 of FIGS. 4A and 4B of test deposit transaction data 185, having the same account ID data in column 421, date and time data in column 427 that fall within a time window defined by window data 306 in FIG. 3, and transaction amount data in column 425 less than a threshold transaction amount indicated in amount data 308 of FIG. 3 are identified and forwarded to confirmed detected test deposit transaction 321. Those transactions that do not have transaction amounts, for both transactions, less than a threshold transaction amount indicated in amount data 308 of FIG. 3 are filtered out at amount less than threshold? 307 and sent to not test deposit 309.

Consequently, the only transactions confirmed as test deposits at confirmed detected test deposit transaction 321 are those transactions that either include text in the description data associated with the transactions indicating the transaction is a test deposit, or that: are pairs of deposit, or debit, transactions into the same disclosed user account; have dates and times within a defined time window; and are less than a defined threshold transaction amount. All other transactions in user transaction data 113 are determined not to be test deposit transactions and are filtered out at not test deposit 309.

Those transactions in user transaction data 113 identified and forwarded to confirmed detected test deposit transaction 321 are then considered indicative of the potential existence of an undisclosed user account and, at determined potential existence of an undisclosed user account 323, account data is collected including all the data currently known about the potential undisclosed account.

The account data associated with the undisclosed account typically includes at least the account ID for the disclosed user account receiving the test deposit transactions, such as account ID data from column 421 in FIGS. 4A and 4B, the date the test deposit transactions were received, such as date/time data from column 427, and the amount of the test deposit transactions, such as amount data from column 427 in FIGS. 4A and 4B.

However, as also noted above, some test deposit transactions also include data that identifies the financial institution sending the test deposit, such source FI data in column 431 in FIGS. 4A and 4B. In these cases, determining the identity of the financial institution associated with the test deposit transactions can be readily accomplished. Consequently, the potential undisclosed account data of determined potential existence of an undisclosed user account 323 is forwarded to check for financial institution identification (FIID) text 325 and processed to detect any data that identifies the financial institution sending the test deposit. Any data identifying the financial institution sending the test deposit is then added to the account data associated with the undisclosed account from determined potential existence of an undisclosed user account 323 to generate potential undisclosed user account data 125 of FIG. 1

Once generated, potential undisclosed user account data 125 is used to add the potential undisclosed user account identified by virtue of detecting test deposit transaction data 185 to user account table 131.

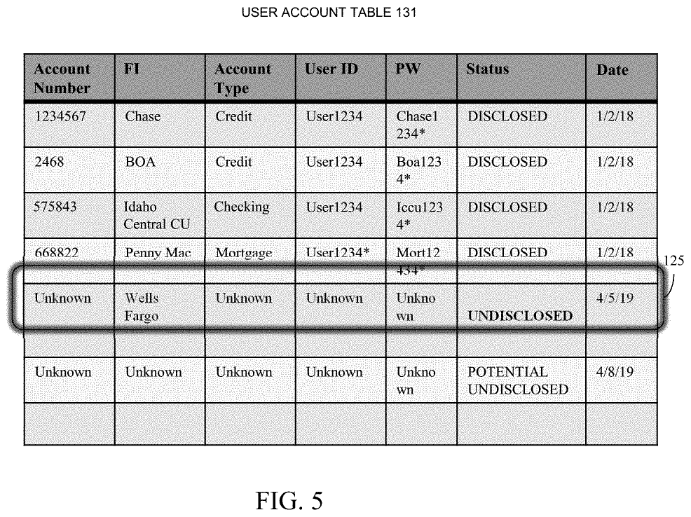

FIG. 5 is an illustrative example of the user account table 131 of FIG. 2 after a potential undisclosed user account is detected, potential undisclosed user account data 125 is generated, and potential undisclosed user account data 125 is added to user account table 131 in accordance with one embodiment.

Referring to FIGS. 3, 4A, 4B and 5 together, FIG. 5 shows potential undisclosed user account data 125 added to user account table 131. As seen in FIG. 5, potential undisclosed user account data 125 in user account table 131 includes: account number data, currently listed as unknown; FI data, identifying the financial institution as determined to be Wells Fargo; account type data, currently shown as unknown; user ID data, currently unknown; password (PW) data, currently unknown; status data indicating the account is currently undisclosed; and date data indicating the potential undisclosed account was added on Apr. 5, 2019.

Returning to FIG. 1, once the potential undisclosed user account data 125 is added to user account table 131, user account table 131, including potential undisclosed user account data 125, is made available to potential undisclosed user account alert processing module 141. Potential undisclosed user account alert processing module 141 is used to a generate potential undisclosed user account alert for the user, provide the potential undisclosed user account alert to user computing system 161 through user interface 151, and process user response data 163 received from the user computing system 161 through user interface 151. User response data 163 is provided by the user in response to the potential undisclosed user account alert.

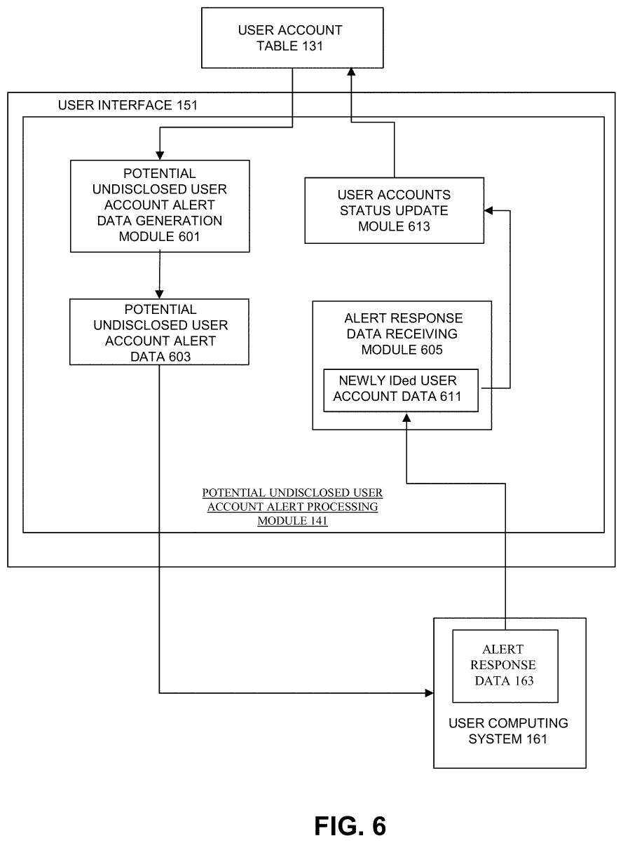

FIG. 6 is a more detailed block diagram of a potential undisclosed user account alert processing module 141 in accordance with one embodiment.

Referring to FIGS. 1, 3, 5 and 6, as seen in FIG. 6, potential undisclosed user account alert processing module 141 in implemented in, or as part of, user interface 151. User account table 131 is made available to potential undisclosed user account alert data generation module 601.

At potential undisclosed user account alert data generation module 601 potential undisclosed user account alert data 603 is generated that represents one or more potential undisclosed user account alerts to be provided to the user of the data management system. The one or more potential undisclosed user account alerts can include information alerting the user to each transaction in user account table 131 having a status of “undisclosed.” The one or more potential undisclosed user account alerts also include a request that the user confirm the existence of each transaction in user account table 131 having a status of “undisclosed,” and provide account data for each transaction in user account table 131 having a status of “undisclosed,” confirmed by the user to exist.

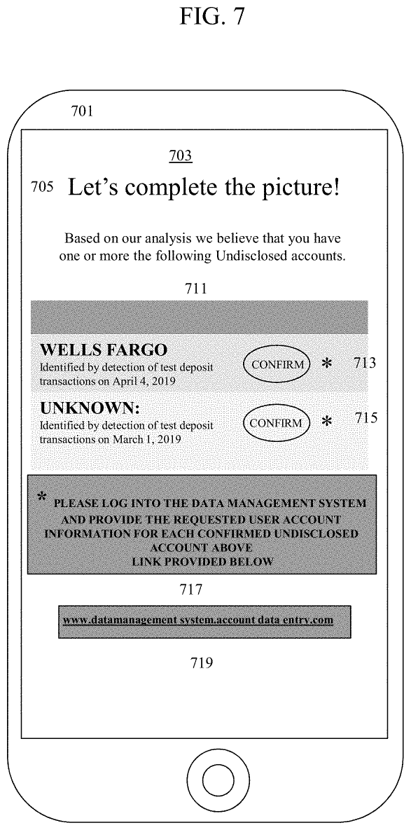

FIG. 7 shows an illustrative example of a potential undisclosed user account alert 703 provided to a user computing system 701 in accordance with one embodiment.

As seen in FIG. 7, in this specific illustrative example, potential undisclosed account alert 703 includes alert text 705 indicating there may be undisclosed accounts.

As seen in FIG. 7, in this specific illustrative example, potential undisclosed account alert 703 includes suggestions field 711 listing potential undisclosed account entries 713 and 715. Account entries 713 and 715 include portions of potential undisclosed user account data 125 for each potential undisclosed account 713 and 715.

In addition, in this specific illustrative example, potential undisclosed account entries 713 and 715 include reason or source data indicating how the potential undisclosed account entry was identified, in this case by test deposit detection. It is also worth noting that while potential undisclosed account entry 713 includes financial institution identification data, i.e., Wells Fargo, the financial institution associated with potential undisclosed account entry 715 is unknown. This indicates that test deposit transaction data associated with potential undisclosed account entry 713 included description data indicating the financial institution sending the test deposit transaction data, while the test deposit transaction data associated with potential undisclosed account entry 715 did not.

In addition, in this specific illustrative example, confirm buttons are included with undisclosed account entry 713 and undisclosed account entry 715. Confirm buttons can be used by the user to easily confirm the existence of the undisclosed accounts of potential undisclosed account entry 713 or potential undisclosed account entry 715.

Also shown in specific illustrative example is text 717 reminding the user to provide newly identified user account data for any confirmed potential undisclosed account entry and a link 719 to the interface page provided by data management system 111 where newly identified user account data can be entered.

Returning to FIG. 6, if the user replies to the potential undisclosed user account alert data, the users' response data is collected in alert response data 163 and provided to alert response data receiving module 605. Consequently, if the user confirms the existence of the undisclosed user account of potential undisclosed user account data 125 indicated in the potential undisclosed user account alert, this confirmation data, along with newly identified user account data 611 is provided to alert response data receiving module 605.

The newly identified user account data 611 can include the same data the user provided for other disclosed accounts in disclosed user account data 115, e.g., the newly identified user account number, the financial institution providing the newly identified user account, the newly identified user account type, the user ID for accessing the newly identified user account, and the password for accessing the newly identified user account.

In addition, if the user confirms the existence of the undisclosed user account of potential undisclosed user account data 125 indicated in the potential undisclosed user account alert, newly identified user account data 611 is provided to user accounts status update module 613 where the status of the undisclosed user account of potential undisclosed user account data 125, now newly identified user account data 611, is transformed to a status of disclosed user account.

Once the newly identified user account data 611 is obtained by user accounts status update module 613, the newly identified user account data 611 is added to the set of disclosed user accounts with the data management system, i.e., the newly identified user account is transformed into a disclosed user account and is added to disclosed user account data 115 and user account table 131 as a disclosed user account.

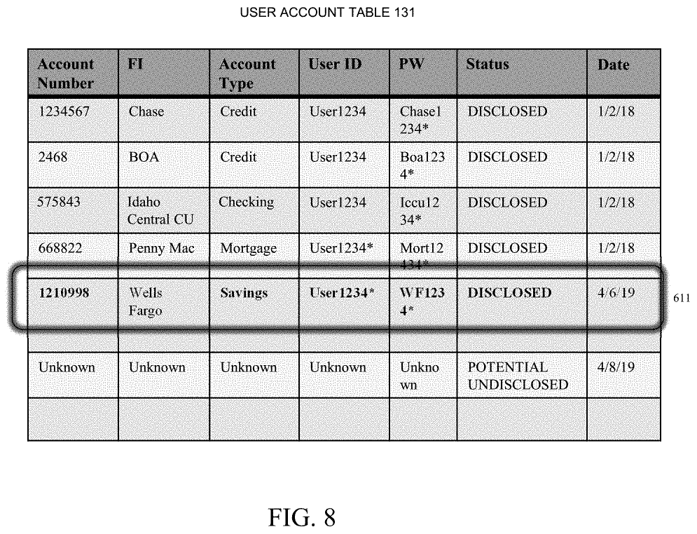

FIG. 8 is an illustrative example of the user account table 131 of FIGS. 2 and 5 after the potential undisclosed user account has been designated a newly disclosed user account and the newly identified user account data has been added to disclosed user account data 115 and user account table 131 as a disclosed user account in accordance with one embodiment.

Referring to FIGS. 3, 4A, 4B, 5, 6 and 8, together, FIG. 8 shows potential undisclosed user account data 125 added to user account table 131. As seen in FIG. 8, the user account table shows potential undisclosed user account data 125 of user account table 131 of FIG. 5, transformed into newly identified user account data 611. Newly identified user account data 611 includes: account number data, transformed from unknown account number to account number 1210998; FI data, still identifying the financial institution as Wells Fargo; account type data, transformed from unknown account type to saving account; user ID data transformed from unknown to User1234*; password (PW) data transformed from unknown to WF1234*; status data transformed from undisclosed to disclosed; and date data still indicating the potential undisclosed account was added on Apr. 5, 2019.

Returning to FIG. 1, once newly identified user account data 611 is added to disclosed user account data 115 and user account table 131 as a disclosed user account, data acquisition module 110 can access account 182 in second financial institution computing system 181 and obtain formally undisclosed user account data 183, now disclosed user account data 183. As a result, formally undisclosed user account data 183, now disclosed user account data 183, can be included in user transaction data 113 so the account data processed by data management system 111 will be more complete. As noted above, this, in turn, means the reports, analysis, recommendations, and other services provided by data management system 111 to the user will be more accurate and up to date.

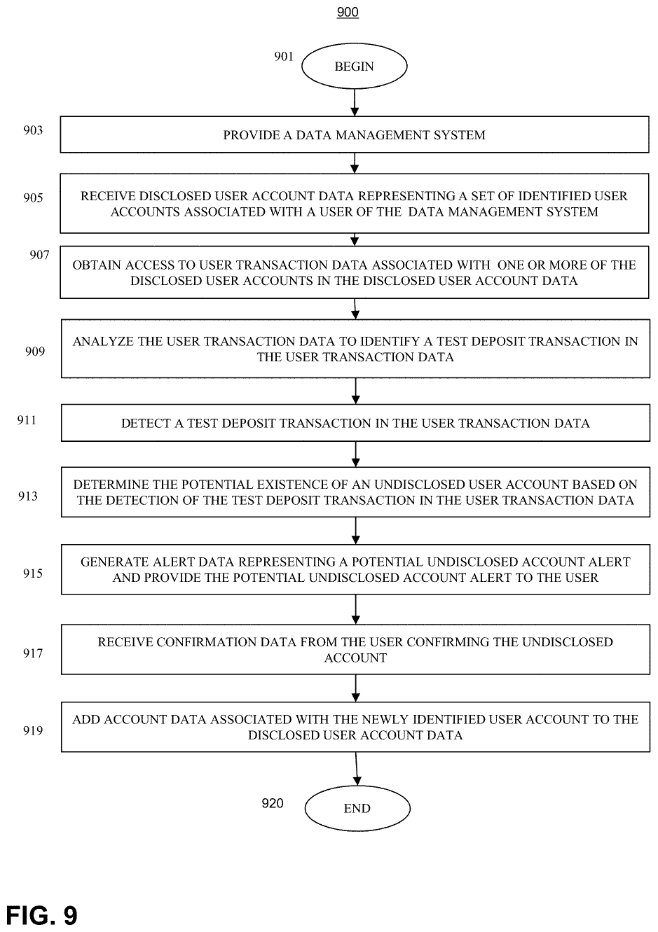

FIG. 9 is a flow chart representing a process 900 for using test deposits to detect undisclosed accounts associated with users of a data management system in accordance with one embodiment.

Referring to FIGS. 1, 2, 3, 4A, 4B, 5, 6, 7, 8, and 9, as seen in FIG. 9, process 900 begins at operation 901 and process flow proceeds to operation 903.

At operation 903 a data management system such as any of the data management systems discussed herein with respect to FIG. 1 or known in the art at the time of filing, or as become known after the time of filing, is provided to one or more users.

Once a data management system is provided at operation 903, process flow proceeds to operation 905.

At operation 905 disclosed user account data representing a set of disclosed user accounts associated with a user of the data management system is received. The disclosed user account data can be any type of disclosed user account data, including that shown and discussed with respect to FIGS. 2, 5, and 8.

Once disclosed user account data representing a set of disclosed user accounts associated with a user of the data management system is received at operation 905, process flow proceeds to operation 907

At operation 907, access is obtained to user transaction data associated with one or more of the disclosed user accounts in the disclosed user account data of operation 905. The user transaction data is user transaction data such as discussed herein with respect to FIGS. 1, 4A and 4B, and is obtained using any of the methods, and from any of the sources, discussed herein with respect to FIGS. 1, 4A and 4B, or known in the art at the time of filing, or as become known after the time of filing.

Once access is obtained to user transaction data associated with one or more of the disclosed user accounts in the disclosed user account data at operation 907, process flow proceeds to operation 909.

At operation 909 the user transaction data of operation 907 is analyzed/processed to identify a test deposit transaction in the user transaction data using any of the methods of processes discussed herein, including those discussed with respect to FIG. 3.

Once the user transaction data is analyzed/processed to identify a test deposit transaction in the user transaction data at operation 909, process flow proceeds to detect a test deposit transaction in the user transaction data operation 911.

At operation 911, as a result of the analysis/process performed at operation 909, one or more test deposit transactions are detected in the user transaction data of operation 907 using any of the methods of processes discussed herein, including those discussed with respect to FIGS. 3, 4A and 4B.

Once one or more test deposit transactions are detected in the user transaction data at operation 911, process flow proceeds to operation 913.

At operation 913 the potential existence of an undisclosed user account is determined based on the detection of the test deposit transaction in the user transaction data at operation 911 using any of the methods of processes discussed herein, including those discussed with respect to FIGS. 3, 4A and 4B.

Once the potential existence of an undisclosed user account is determined based on the detection of the test deposit transaction in the user transaction data at operation 913, process flow proceeds to operation 915.

At operation 915, data representing a potential undisclosed account alert is generated and the potential undisclosed account alert is provided to the user. The potential undisclosed account alert requests the user confirm the existence of the undisclosed user account associated with the detection of the test deposit transaction and this response is processed using any of the methods and systems discussed herein, including the methods and systems discussed with respect to FIGS. 1, 6, and 7.

Once the potential undisclosed account query alert is provided to the user at operation 915, process flow proceeds to operation 917.

At operation 917 the user confirms the existence of the undisclosed user account using any of the methods and systems discussed herein, including the methods and systems discussed with respect to FIGS. 1, 6, and 7.

Once the user confirms the existence of the undisclosed user account at operation 917, process flow proceeds to operation 919.

At operation 919 the undisclosed user account is designated a newly identified user account, and account data associated with the newly identified user account is obtained and added to the disclosed user account data using any of the methods and systems discussed herein, including the methods and systems discussed with respect to FIGS. 1, 6, 7, and 8.

Once the newly identified user account is obtained and added to the disclosed user account data at operation 919, process flow proceeds to end operation 920 and process 900 is exited to await new data.

In the discussion above, certain aspects of one embodiment include process steps and/or operations and/or instructions described herein for illustrative purposes in a specific order and/or grouping. However, the specific order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the specific order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various users under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

In addition, the operations shown in the FIGs., or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method comprising:
receiving, with the one or more computing systems, a set of disclosed user accounts associated with a user of a data management system;
obtaining access to user transactions associated with one or more of the disclosed user accounts;
analyzing the user transactions to identify a test deposit transaction;
detecting a test deposit transaction;
determining the potential existence of an undisclosed user account based on the detection of the test deposit transaction;
requesting the user confirm the existence of the undisclosed user account associated with the detection of the test deposit transaction;
if the user confirms the existence of the undisclosed user account, transforming a status of the potential undisclosed user account to newly identified user account and obtaining account associated with the newly identified user account; and
adding the newly identified user account to the set of disclosed user accounts.

2. The computing system implemented method of claim 1 wherein analyzing the user transactions to identify a test deposit transaction includes analyzing the user transactions to identify a pair of transactions having transaction times within a same defined transaction time window and having transaction amounts less than a defined threshold transaction amount.

3. The computing system implemented method of claim 2 wherein the transaction time window is defined as a one-hour time window and the threshold transaction amount is one US dollar.

4. The computing system implemented method of claim 1 wherein analyzing the user transactions to identify a test deposit transaction includes analyzing the user transactions to identify a transaction having a description indicating the transaction is a test deposit transaction.

5. The computing system implemented method of claim 1 further comprising:
when a test deposit transaction is detected, analyzing the test deposit transaction to identify a financial institution generating the test deposit;
in response to identifying a financial institution generating the test deposit, requesting the user confirm the existence of the undisclosed user account with the identified financial institution associated with the detection of the test deposit transaction;
if the user confirms the existence of the undisclosed user account with the identified financial institution associated with the detection of the test deposit transaction, designating the undisclosed user account as a newly identified user account with the identified financial institution and obtaining newly identified user account data representing the newly identified user account; and
adding the newly identified user account to the set of disclosed user accounts.

6. A method comprising:
receiving, through a data management system provided by one or more computing systems, disclosed user account data, the disclosed user account data representing a set of disclosed user accounts associated with a user of a data management system;
generating, with the one or more computing systems, a user account table, the user account table including the set of disclosed user accounts and a set of potential undisclosed user accounts associated with the user;
for each disclosed user account within the set of disclosed user accounts, accessing user transactions associated with the user;
detecting, based on analyzing the user transactions, a test deposit transaction;
detecting a potential undisclosed user account based on the detected test deposit transaction; and
adding the potential undisclosed user account to the set of potential undisclosed accounts in the user account table data.

7. The method of claim 6 wherein analyzing the user transactions to detect a test deposit transaction includes analyzing the user transactions to detect a pair of transactions having transaction times within a same defined transaction time window and having transaction amounts less than a defined threshold transaction amount.

8. The method of claim 7 wherein requesting the user confirm the existence of the undisclosed user account associated with the detection of the test deposit transaction is performed by generating potential undisclosed user account alert data representing a potential undisclosed user account alert and providing the potential undisclosed user account alert to the user.

9. The method of claim 6 wherein analyzing the user transactions to detect a test deposit transaction includes analyzing the user transactions to detect a transaction having description data indicating the transaction is a test deposit transaction.

10. The method of claim 6 further comprising:
requesting the user confirm the existence of the potential undisclosed user account associated with the detection of the test deposit transaction in the set of potential undisclosed user accounts;
if the user confirms the existence of the potential undisclosed user account, transforming a status of the potential undisclosed user account to newly identified user account and obtaining account data representing the newly identified user account; and
adding the account data representing the newly identified user account to the disclosed user account data.

11. The method of claim 10 further comprising:
when a test deposit transaction is detected, analyzing the test deposit transaction to identify a financial institution generating the test deposit;
in response to identifying a financial institution generating the test deposit, requesting the user confirm the existence of the potential undisclosed user account with the identified financial institution associated with the detection of the test deposit transaction;
if the user confirms the existence of the potential undisclosed user account with the identified financial institution associated with the detection of the test deposit transaction, designating the potential undisclosed user account as a newly identified user account with the identified financial institution and obtaining newly identified user account data representing the newly identified user account; and
adding the newly identified user account data to the disclosed user account data of the user account table.

12. The method of claim 6 wherein the user is requested to confirm the existence of the potential undisclosed user account associated with the detection of the test deposit transaction the next time the user signs on with the data management system.

13. The method of claim 6 wherein the user is requested to confirm the existence of each potential undisclosed user account in the user account table each time the user signs on with the data management system.

14. A system comprising:
at least one processor; and
at least one memory coupled to the at least one processor, the at least one memory having stored therein instructions which, when executed by any set of the one or more processors, perform a process including:
receiving disclosed user account data, the disclosed user account data representing a set of disclosed user accounts associated with a user of a data management system;
obtaining access to user transaction data associated with one or more disclosed user accounts listed in the disclosed user account data;
analyzing the user transaction data to identify a test deposit transaction in the user transaction data;
detecting a test deposit transaction in the user transaction data;
determining the potential existence of an undisclosed user account based on the detection of the test deposit transaction in the user transaction data;
requesting the user confirm the existence of the undisclosed user account associated with the detection of the test deposit transaction;
if the user confirms the existence of the undisclosed user account, transforming a status of the potential undisclosed user account to newly identified user account and obtaining account data representing the newly identified user account; and
adding the newly identified user account data to the disclosed user account data.

15. The system of claim 14 wherein analyzing the user transaction data to identify a test deposit transaction in the user transaction data includes analyzing the user transaction data to identify a pair of transactions having transaction times within a same defined transaction time window and having transaction amounts less than a defined threshold transaction amount.

16. The system of claim 15 wherein requesting the user confirm the existence of the undisclosed user account associated with the detection of the test deposit transaction is performed by generating potential undisclosed user account alert data representing a potential undisclosed user account alert and providing the potential undisclosed user account alert to the user.

17. The system of claim 14 wherein analyzing the user transaction data to identify a test deposit transaction in the user transaction data includes analyzing the user transaction data to identify a transaction represented in the transaction data having description data indicating the transaction is a test deposit transaction.

18. The system of claim 14 further comprising:
when a test deposit transaction is detected in the user transaction data, analyzing the transaction data associated with the test deposit transaction to identify a financial institution generating the test deposit;
in response to identifying a financial institution generating the test deposit, requesting the user confirm the existence of the undisclosed user account with the identified financial institution associated with the detection of the test deposit transaction;
if the user confirms the existence of the undisclosed user account with the identified financial institution associated with the detection of the test deposit transaction, designating the undisclosed user account as a newly identified user account with the identified financial institution and obtaining newly identified user account data representing the newly identified user account; and
adding the newly identified user account data to the disclosed user account data.

19. The system of claim 14 wherein the user is requested to confirm the existence of the potential undisclosed user account associated with the detection of the test deposit transaction the next time the user signs on with the data management system.

20. The system of claim 14 further comprising:
generating user account table data representing a user account table, the user account table including a set of the disclosed user accounts associated with the user indicated in the disclosed user account data and a set of potential undisclosed user accounts associated with the user; and
requesting the user confirm the existence of each potential undisclosed user account in the user account table each time the user signs on with the data management system.
